(19) United States
(12) Patent Application Publication
(10) Pub. No.: US 2026/0160190 A1
(43) Pub. Date: Jun. 11, 2026

(54) VALVE GUIDE FOR GUIDING A VALVE STEM

(71) Applicant: INNIO Jenbacher GmbH & Co OG, Jenbach (AT)

(72) Inventors: Lukas Zahner, Rosenheim (DE); Yves-Vincent Abgrall, Innsbruck (AT)

(21) Appl. No.: 19/409,383

(22) Filed: Dec. 4, 2025

(30) Foreign Application Priority Data
Dec. 5, 2024 (EP) 24217757.4

(51) Int. Cl. F01L 3/08; F01L 1/46; F16K 1/32

(52) U.S. Cl. CPC F01L 3/08; F01L 1/462; F16K 1/32

(57) ABSTRACT

Valve guide for guiding a valve stem of an internal combustion engine, including a first cylindrical guiding surface for guiding a valve stem of an intake valve or an exhaust valve along a guiding axis and a second cylindrical guiding surface for guiding the valve stem of the intake valve or the exhaust valve along the guiding axis. The first guiding surface and the second guiding surface are distanced axially along the guiding axis. An annular groove is provided axially between the first guiding surface and the second guiding surface for receiving an O-ring for sealing the valve stem. A radial shaft seal is provided axially distanced from the annular groove such that the second guiding surface is arranged axially between the annular groove and the radial shaft seal.

### CROSS-REFERENCE TO RELATED APPLICATION

This application claims priority to and benefit of European patent Application No. EP 24217757.4, filed on Dec. 5, 2024, entitled “VALVE GUIDE FOR GUIDING A VALVE STEM”, which is herein incorporated by reference in its entirety.

### FIELD OF THE INVENTION

The present disclosure concerns a valve guide for guiding a valve stem of an internal combustion engine.

### BACKGROUND

Intake valves of internal combustion engines are used to control the supply of fuel, air and/or air-fuel mixture into the main combustion engine. Exhaust valves of internal combustion engine are used to control the outlet of exhaust gases from the main combustion engine after combustion an air-fuel mixture inside the main combustion engine.

Therefore, it is important that intake valves and/or exhaust valves are exactly guided to generate on the one hand an effective sealing of the main combustion chamber during combustion stroke and on the other hand to provide exact opening and closing times of the valves.

Valve guides generally guide the intake valve or the exhaust valve by use of cylindrical guiding surfaces, wherein the guiding surfaces interact with the valve stem of the intake valve or the exhaust valve to guide the valve along a guiding axis.

These guiding surfaces of the valve guide are manufactured with high surface quality to reduce friction and realize high lifetime.

Furthermore, a lubricant may be used for the contact surfaces to increase lifetime, wherein in most cases an engine oil already present in a cavity above the valve guidance is used.

A double lip seal may be used to provide a more exact metering of the lubricant. Examples of valve stem seals are disclosed, for example, in U.S. Pat. Nos. 5,110,142 and 4,834,037.

Another way for a metering of the lubricant is to provide O-rings placed inside the valve guide interacting with the outer surface of the valve stem, as, e.g., disclosed by EP 2 540 999 A1.

Analyses of the applicant have shown that these systems are not reliable for a continued metering of oil during the life time of the valve guide, as gasses (e.g., exhaust gasses) passing though the gap between valve stem and the guiding surface are blocked by the oil metering system, wherein deposits are build up at the oil metering device provided by the interaction of the hot gases and the lubricant confronted at the oil metering device.

These deposits do mainly affect the lifetime of the valves and the valve guide, as they support the friction between the guiding surfaces and increase the wearing between the guiding surfaces.

Furthermore, the metering device is affected by the deposits, wherein during lifetime more and more lubricant or oil is provided to the contact surface, which surplus of lubricant is passed into the combustion process and does mainly affect the emissions created in the combustion.

### BRIEF DESCRIPTION

An aspect of the present disclosure is to provide a valve guide and/or an cylinder head comprising a valve guide, wherein at least partially the above identified disadvantages of the state of the art can be improved and/or wherein the metering of lubrication can be improved and/or wherein the wear can be reduced and/or wherein the lifetime can be improved and/or wherein the emissions of the internal combustion engine can be reduced.

This aspect is achieved with a valve guide for guiding a valve stem of an internal combustion engine and/or a cylinder head having the characteristics described in further detail below.

A valve guide according to the present disclosure comprises a first cylindrical guiding surface for guiding a valve stem of a poppet valve (e.g., an intake valve or an exhaust valve) along a guiding axis and a second cylindrical guiding surface for guiding the valve stem of the intake valve or the exhaust valve along the guiding axis, wherein
the first guiding surface and the second guiding surface are distanced axially along the guiding axis,
an annular groove is provided axially between the first guiding surface and the second guiding surface for receiving an O-ring for sealing the valve stem,
a radial shaft seal is provided axially distanced from the annular groove such that the second guiding surface is arranged axially between the annular groove and the radial shaft seal.

Analysis carried out by the applicant has shown that the combination of an O-ring as a seal and a radial shaft seal—highly surprisingly—results in a significantly longer lifetime of the valve guide disproportionate to the effects of the O-ring and the radial shaft seal on their own.

It is believed that the O-ring interacts with the valve stem such that gases—especially exhaust gasses—passing through are prevented, such that deposits building up at the radial shaft seal are also prevented.

As the build up of deposits in the area of the radial shaft seal are prevented or reduced, the operation and function of the radial shaft seal is no longer affected by these deposits.

As a result of that the lifetime of the radial shaft seal is improved as the wear of radial shaft seal affected by deposits is reduced.

Furthermore, as the wear is reduced, the oil metering of the radial shaft seal can be obtained more precise for more operating hours, wherein also the lifetime of the valves by a reduction of wear by use of a more efficient lubrication can be increased.

This in turn improves the lifetime of the O-ring. Consequently, the O-ring and the radial shaft seal form a mutually supportive and symbiotic system.

Also, the emissions of the internal combustion engine (which has been increased by oil or lubricant passing into the combustion process by worn seals) can be reduced or kept constant.

The radial shaft seal is also known as a lip seal.

Already present internal combustion engines can be upgraded and operated with a valve guide according to the present disclosure. Therefore, the present disclosure can be used for the embodiments of the prior art already described in the introduction of the description.

The present disclosure can particularly preferably be used in conjunction with an internal combustion engine driving a generator for creating electrical energy. Such combinations of internal combustion engines driving a generator are known as gensets.

The internal combustion engine or genset can preferably be stationary or for naval use.

Advantageous embodiments are defined in the dependent claims.

It can be provided that the valve guide comprises a base body having a mounting surface for mounting the valve guide, preferably by use of a press-fit, at a cylinder head of the internal combustion engine.

The base body of the valve guide can be cylindrical.

The radial shaft seal can be provided at a radial step of the base body, preferably at the upper end, particular preferred wherein the upper end of the base body is at least partially covered by the radial shaft seal.

A lip of the radial shaft seal—preferably of the lip seal—can be provided by an elastic material, preferably PTFE (Polytetrafluorethylene).

It can be provided that the radial shaft seal comprises a first lip, preferably a dust lip, and a second lip, preferably a sealing lip, wherein the first lip and the second lip of the radial shaft seal are distanced along the guiding axis.

It can be provided that the second lip, preferably the sealing lip, is pre-loaded by use of a garter spring also known as tube spring. Formulated differently the pre-load can be realized by a body of roughly cylindrical topology with radial spring action.

The O-ring can be provided by an elastic material, preferably fluoropolymer rubber.

Furthermore, protection is sought for a cylinder head for an internal combustion engine comprising a valve guide according to the present disclosure, wherein the valve guide is arranged, preferably by use of a press-fit, at least partially inside a corresponding opening of the cylinder head, wherein an intake valve or exhaust valve is guided along the guiding axis at the guiding surface of the valve guide.

It can be provided that the radial shaft seal is placed in the valve guide in such a way to prevent a passing of lubricant disposed in the valve guide to an outside of the valve guide.

It can be provided that the intake valve or exhaust valve is pre-loaded with respect to a valve seat by use of at least one spring element.

Also, protection is sought for an internal combustion engine comprising a valve guide or a cylinder head according to the present disclosure.

### BRIEF DESCRIPTION OF THE DRAWINGS

Further details and advantages of the present disclosure are apparent from the accompanying figures and the following description of the drawings. The figures show:

FIG. 1 illustrates a first embodiment of a poppet valve (e.g., an exhaust valve) mounted inside a cylinder head of an internal combustion engine,

FIG. 2 illustrates a detail view A indicated in FIG. 1,

FIG. 3 illustrates a radial shaft seal of FIGS. 1 and 2 in detail, and

FIG. 4 illustrates a detail view B indicated in FIG. 1.

### DETAILED DESCRIPTION

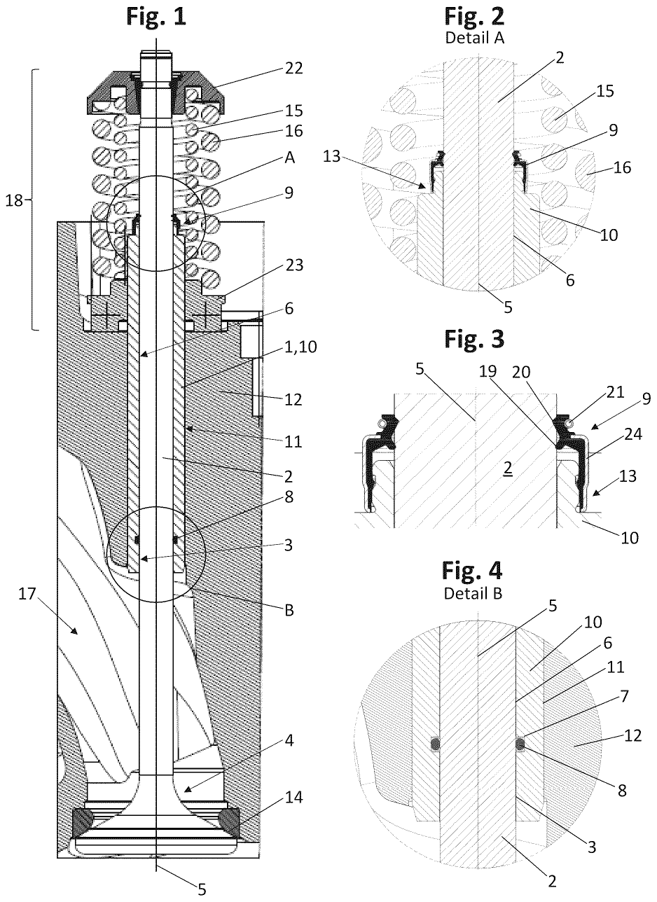

FIG. 1 shows a first embodiment of a poppet valve (e.g., an exhaust valve 4) mounted inside the cylinder head 12.

To show each detail of this embodiment FIG. 2 presents detail A and FIG. 4 detail B both indicated in FIG. 1.

FIG. 3 presents the radial shaft seal 9 (e.g., annular seal, lip seal) used in the embodiment of FIG. 1 in an increased manner to indicate each component of this radial shaft seal 9.

The exhaust valve 4 used to control an exiting of exhaust gas from a combustion chamber of the internal combustion engine into the exhaust port 17 is placed axially guided along the guiding axis 5 in the cylinder head 12.

Therefore, the exhaust valve 4 is placed with the valve stem 2 inside the valve guide 1, wherein the valve stem 2 of the exhaust valve 4 is guided by the guiding surfaces 3, 6 (e.g., inner annular or cylindrical guiding surfaces) of the valve guide 1 along the guiding axis 5. The exhaust valve 4 has a valve head coupled to the valve steam 2, wherein the valve head is configured to open and close against a valve seat 14.

The exhaust valve 4 is pre-loaded with respect to the valve seat 14 by use of the spring elements 15, 16.

The spring elements 15, 16 are combined to a spring package 18 by use of upper and lower spring plates 22, 23.

The lower spring plate 23 is screwed with the cylinder head 12 and the upper spring plate 22 is axially joined to the valve stem 2, preferably by use of a snap ring.

The valve guide 1 is arranged with its cylindrical base body 10 by use of a press-fit inside a corresponding opening of the cylinder head 12, wherein the exhaust valve 4 is guided along the guiding axis 5 at the guiding surface 3, 6 of the valve guide 1.

The valve guide 1 comprises a first guiding surface 3 (e.g., inner annular or cylindrical guiding surface) and a second guiding surface 6 (e.g., inner annular or cylindrical guiding surface) distanced axially along the guiding axis 5.

Axially between the first guiding surface 3 and the second guiding surface 6 an annular groove 7 (e.g., seal groove or seal mount) is provided for receiving an O-ring 8 (e.g., annular seal) for sealing the valve stem 2.

Furthermore, a radial shaft seal 9 (e.g., annular seal, lip seal) is provided axially distanced from the annular groove 7, such that the second guiding surface 6 is arranged axially between the annular groove 7 and the radial shaft seal 9.

The base body 10 of the valve guide 1 comprises a mounting surface 11 for mounting the valve guide 1 by use of a press-fit at a cylinder head 12.

The radial shaft seal 9 is provided at a radial step 13 (e.g., annular stepped recess, seal mount) of the base body 10 at the upper end (e.g., axial end portion), wherein the upper end of the base body 10 is partially covered by the radial shaft seal 9.

This radial shaft seal 9 is provided by an elastic material, wherein in the region of the metal ring 24 (e.g., outer protective sleeve, annular sleeve, annular metallic cover) of the radial shaft seal 9, the elastic material is deformed and pressed against the radial step 13 of the base body 10 for attaching and saving the radial shaft seal 9 at the base body 10.

The radial shaft seal 9 (e.g., annular seal, lip seal) comprises a first lip (e.g., inwardly radially protruding annular lip), namely the dust lip 19, and a second lip (e.g., inwardly radially protruding annular lip), namely a sealing lip 20, wherein the dust lip 19 and the sealing lip 20 are distanced along the guiding axis 5. As illustrated, the radial shaft seal 9 is disposed at the upper end (e.g., axial end portion) of the base body 10, extends around an outer annular surface of the base body 10 at the axial end portion, extends around an axial distal end of the base body 10, and the lips (e.g., dust lip 19 and sealing lip 20) extend radially inward to seal against the valve stem 2.

The sealing lip 20 pre-loaded with respect to the valve stem 2 by use of the garter spring 21 (e.g., annular spring).

### LIST OF USED REFERENCE SIGNS

1 valve guide
2 valve stem
3 first cylindrical guiding surface
4 exhaust valve
5 guiding axis
6 second cylindrical guiding surface
7 annular groove
8 O-ring
9 radial shaft seal
10 base body
11 mounting surface
12 cylinder head
13 radial step of the base body
14 valve seat
15 spring element
16 spring element
17 exhaust port
18 spring package
19 dust lip
20 sealing lip
21 garter ring
22 upper spring plate
23 lower spring plate
24 metal ring

1. A system, comprising:
a valve guide configured to guide a valve stem of an internal combustion engine, wherein the valve guide comprises a first cylindrical guiding surface configured to guide the valve stem of an intake valve or an exhaust valve along a guiding axis and a second cylindrical guiding surface configured to guide the valve stem of the intake valve or the exhaust valve along the guiding axis, wherein
the first cylindrical guiding surface and the second cylindrical guiding surface are distanced axially along the guiding axis,
an annular groove is provided axially between the first cylindrical guiding surface and the second cylindrical guiding surface, wherein the annular groove is configured to receive an O-ring to seal the valve stem,
a radial shaft seal is provided axially distanced from the annular groove such that the second cylindrical guiding surface is arranged axially between the annular groove and the radial shaft seal.

2. The system of claim 1, wherein the valve guide comprises a base body having a mounting surface configured to mount the valve guide at a cylinder head of the internal combustion engine.

3. The system of claim 2, wherein the base body of the valve guide is cylindrical.

4. The system of claim 2, wherein the radial shaft seal is provided at a radial step of the base body, at the upper end, wherein the upper end of the base body is at least partially covered by the radial shaft seal.

5. The system of claim 1, wherein at least one lip of the radial shaft seal comprises an elastic material including PTFE.

6. The system of claim 1, wherein the radial shaft seal comprises a first lip being a dust lip and a second lip being a sealing lip, wherein the first lip and the second lip of the radial shaft seal are distanced along the guiding axis.

7. The system of claim 1, comprising the O-ring disposed in the annular groove, wherein the O-ring comprises an elastic material including fluoropolymer rubber.

8. The system of claim 1, comprising:
a cylinder head for the internal combustion engine; and
the intake valve or the exhaust valve, wherein the valve guide is press-fit at least partially inside a corresponding opening of the cylinder head, wherein the intake valve or exhaust valve is guided along the guiding axis at the first and second cylindrical guiding surfaces of the valve guide.

9. The system of claim 8, wherein the radial shaft seal is placed in the valve guide in such a way to prevent a passing of lubricant disposed in the valve guide to an outside of the valve guide.

10. The system of claim 7, wherein the intake valve or the exhaust valve is pre-loaded with respect to a valve seat via at least one spring.

11. The system of claim 1, comprising the internal combustion engine having the valve guide.

12. A system, comprising:
a valve guide configured to guide a valve stem of a poppet valve, wherein the valve guide comprises:
a first guiding surface configured to guide the valve stem of the poppet valve along a guiding axis;
a second guiding surface configured to guide the valve stem of the poppet valve along the guiding axis, wherein the first and second guiding surfaces are axially offset from one another along the guiding axis;
a first seal mount disposed at a first axial position along the valve guide axially between the first and second guiding surfaces, wherein the first seal mount is configured to receive a first annular seal; and
a second seal mount disposed at a second axial position axially offset from the first axial position along the valve guide, wherein the second guiding surface is axially between the first and second seal mounts, and the second seal mount is configured to receive a second annular seal.

13. The system of claim 12, wherein the first seal mount comprises an annular groove along an interior of the valve guide between the first and second guiding surfaces.

14. The system of claim 13, comprising a first annular seal disposed in the annular groove.

15. The system of claim 13, wherein the second seal mount is disposed at an axial end portion of the valve guide.

16. The system of claim 15, wherein the second seal mount comprises a radial step in a radially outer surface of the valve guide at the axial end portion, and the radial step is disposed directly adjacent a distal axial end of the of the valve guide.

17. The system of claim 15, comprising the second annular seal disposed at the axial end portion, wherein the second annular seal comprises a plurality of lips extending radially inwardly toward the guiding axis.

18. A method, comprising:
guiding a valve stem of a poppet valve along a guiding axis of a valve guide via a first guiding surface of the valve guide;
guiding the valve stem of the poppet valve along the guiding axis of the valve guide via a second guiding surface of the valve guide, wherein the first and second guiding surfaces are axially offset from one another along the guiding axis;
sealing a poppet valve with a first annular seal coupled to a first seal mount at a first axial position along the valve guide axially between the first and second guiding surfaces; and
sealing the poppet valve with a second annular seal coupled to a second seal mount at a second axial position axially offset from the first axial position along the valve guide, wherein the second guiding surface is axially between the first and second seal mounts.

19. The method of claim 18, wherein sealing the poppet valve with the first annular seal occurs along an interior of the valve guide between first and second distal axial ends of the valve guide, and sealing the poppet valve with the second annular seal occurs at the first distal axial end of the valve guide.

20. The method of claim 19, wherein sealing the poppet valve with the second annular seal comprises sealing with a plurality of lips of the second annular seal.
